(19) United States
(12) Patent Application Publication
(10) Pub. No.: US 2012/0204808 A1
(43) Pub. Date: Aug. 16, 2012

(54) Exercise Pad For Declawed Cats

(76) Inventors: Marianne Shenefelt, Cheyenne, WY (US); Francis T. Shenefelt, Cheyenne, WY (US)

(21) Appl. No.: 13/371,345

(22) Filed: Feb. 10, 2012

Related U.S. Application Data
(60) Provisional application No. 61/463,048, filed on Feb. 10, 2011.

(51) Int. Cl. A01K 15/02; A01K 29/00

(52) U.S. Cl. 119/706

(57) ABSTRACT

An exercise pad for declawed cats utilizes corrugated cardboard or similar materials formed into a pad having a ledge and rims designed to allow a declawed cat to properly scratch, stretch and exercise. The corrugations are stacked vertically and a rectangular block is created. On three sides of the block, a ledge is formed. This creates a tiered appearance and provides the cat with multiple edges or rims upon which to hook its paws. These specially provided rims provide the declawed cat some texture that gives a unique resistant yet satisfying “give” to the paws when used in the normal scratching action. The ledge can be formed on two sides and an overhang created on the other two sides so regardless of whether the top or bottom is face-up, the cat has access to both the rims created by the ledge and the overhang edges.

### CROSS-REFERENCE TO RELATED APPLICATIONS

The application claims benefit of U.S. Provisional Application No. 61/463,048 entitled “Exercise Pad for Declawed Cats” and filed on Feb. 10, 2011, which is specifically incorporated by reference herein for all that it teaches and discloses.

### TECHNICAL FIELD

The invention relates generally to exercise devices for animals, and more particularly to a exercise pad for declawed cats.

### BACKGROUND

There are many types of animals that have been domesticated for co-habitation with humans. One of the most common is Felis catus, the house cat. Cats have been associated with humans for at least 9,500 years and as of 2009 were found to be the most popular pet in the world. Cat companions, or pets, provide many benefits to their owners, but there are some disadvantages as well. One of the most destructive of these is the cats' need to scratch objects using its front paws and claws.

Scratching is a natural behavior in cats wherein they periodically hook their front claws into suitable surfaces and pull backwards, dragging their claws along or through the surface. This act serves a number of purposes for cats, including: marking territory (the scent-glands in the pads of their front paws mark objects that are scratched), exercising (the stretching and pulling actions tone muscles, strengthen bones, etc.), and cleaning and sharpening claws. However, scratching can be an exceedingly destructive activity inside a house or apartment. Many scratching posts, pads, etc. are currently available on the market which help to focus a cat's natural scratching behavior on an acceptable object rather than on furniture, carpet, or other easily-damaged objects. Nevertheless, scratching of non-acceptable objects can continue to occur. Furthermore, cats that have sharp claws can easily cause injury to people or other pets, either inadvertently or intentionally. For these reasons, and perhaps others, many cat owners choose to have their cats undergo onychectomy, commonly known as declawing. This is a surgical process in which the claw and first bone of each digit of a cat's paw are removed, usually from just the front paws, but sometimes from all four paws.

Cats that have been declawed will often continue to engage in scratching behavior, but the behavior is no longer nearly as destructive to their owners' house and possessions. The need and desire to carry out the instinctive act of scratching remains after declawing because this behavior is fundamental to a cat's overall well-being and good health. Consequently, it is important to provide the declawed cat appropriate opportunities to continue scratching and sustain the associated benefits from the behavior.

Despite the obvious need for scratching devices for declawed cats, few, if any, are currently known in the art. Some declawed cats will use traditional scratching devices, but the hard edges, wood, rope, etc. that work well for clawed cats are not conducive to scratching and/or exercising for declawed cats.

Thus, there exists a need for a cat exercising pad that encourages declawed cats to scratch, exercise, and stretch.

### SUMMARY

One embodiment of the present invention utilizes stacks of corrugated, honeycombed, or similar materials having both structure as well as empty air-pockets, hereinafter “corrugation”. A commonly available and acceptable material is corrugated cardboard. The invention comprises sheets of corrugation positioned vertically and adhered together into a multi-layer sandwich or block. Care needs to be taken to ensure that the air-pockets within the corrugation are not crushed while constructing the block. In one embodiment, the height of the corrugation is approximately two inches, while the other dimensions of the block are approximately eighteen to twenty inches long by ten to twelve inches wide. Other embodiments use blocks of corrugation having differing dimensions.

On three sides of the block, a ledge approximately one inch deep and one inch high should be cut into the block. This creates a tiered appearance and provides the declawed cat with multiple edges upon which to hook its paws. It is important that the block not have hard edges, or hard rims, nor should it be encased in protective edge materials as is common practice in cat scratchers designed for cats with claws. Instead, the relatively soft rims, provided by the transition from the vertical corrugation on the outside walls of the block to the horizontal surface of the ledge and from the vertical corrugation on the walls of the ledge to the horizontal top surfaces of interior corrugations, allow declawed cats an edge upon which they can hook their digits—something the flat top surfaces of known scratchers do not provide. These specially provided rims provide the declawed cat with some texture that gives a unique resistant yet satisfying “give” to the paws of the declawed cat when used in the normal scratching action. One side of the block has a full height exterior wall without a ledge to provide the cat with a single rim that has a different configuration than the remainder of the device.

Because the declawed cat exercise pad has the ledge, it can be inverted and will provide additional utility to the declawed cat. Once the exercise pad is turned over, a cat can reach under the pad and hook its paws on what is now the underside of an overhang. This unique feature is beneficial, not only for the prolonged use of the exercise pad, but also because once the pad has been scent marked by the cat it is comforting and reassuring to them to continue to use it. The exercise pad has become “personalized” territory and is full of their scent.

In another embodiment, the ledge is formed on two sides and the overhang is formed on the other two sides so regardless whether the top or bottom is face-up, the cat has access to both the rims created by the ledge and the overhang edges as well. In yet other embodiments, one to three sides have a ledge and one to three sides have an overhang. It is important to understand that additional ledges and/or overhangs could be added to the design in other embodiments so that instead of the block having a two-tiered appearance, it could have three, four, or more tiers.

### BRIEF DESCRIPTION OF THE DRAWINGS

FIG. 1 shows a perspective view of an exemplary embodiment of an exercise pad for declawed cats being used by a declawed cat;

FIG. 2 illustrates a perspective view of an exemplary embodiment of an exercise pad showing a ledge and a top surface;

FIG. 3A illustrates a side elevational view of the front side of an exemplary embodiment of an exercise pad;

FIG. 3B illustrates a side elevational view of the rear side of an exemplary embodiment of an exercise pad;

FIG. 3C illustrates a side elevational view of the left side of an exemplary embodiment of an exercise pad;

FIG. 3D illustrates a side elevational view of the right side of an exemplary embodiment of an exercise pad; and

FIG. 4 illustrates a top plan view of an exemplary embodiment of an exercise pad for declawed cats.

### DETAILED DESCRIPTION

Referring now to the drawings, exemplary embodiments of the invention are described below in the accompanying Figures. The following detailed description provides a comprehensive review of the drawings in order to provide a thorough understanding of, and an enabling description for, these embodiments. One having ordinary skill in the art will understand that the invention may be practiced without certain details. In other instances, well-known structures and functions have not been shown or described in detail to avoid unnecessarily obscuring the description of the embodiments.

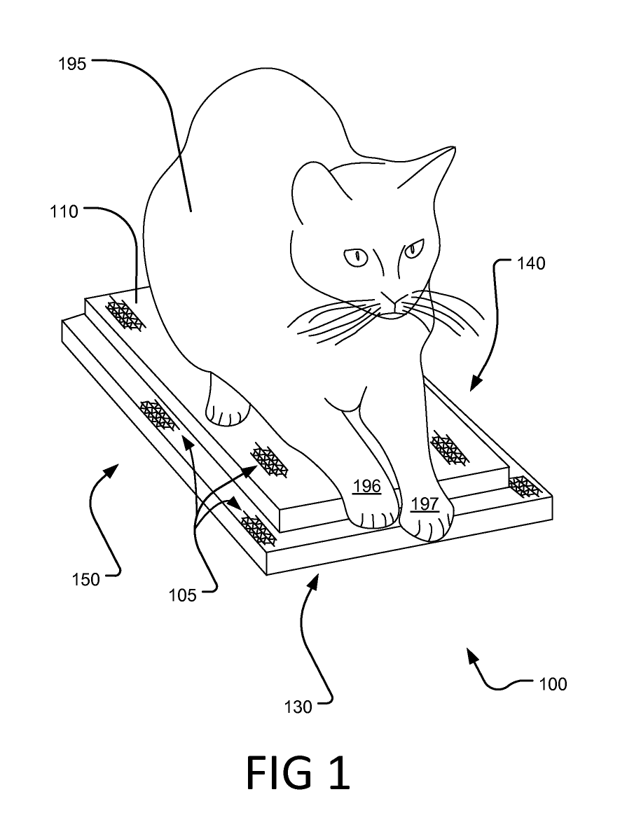

FIG. 1 shows a perspective view of an exemplary embodiment of an exercise pad for declawed cats 100 being used by a declawed cat 195. The cat 195 is positioned on the top surface 110 of the exercise pad 100. A method of using the pad 100 is shown wherein the cat 195 places one or both front paws 196 and 197 over the edge (formed by the junction of the top surface 110 and a side surface, in this case the front side 130). The cat 195 can then pull its front paws 196 and 197 towards its body, grasping the edge with its paws. This motion is similar to that undertaken by a non-declawed cat during normal scratching activity.

A more detailed explanation of the method by which a cat 195 uses the device is as follows. To begin, the declawed cat 195 approaches the exercise pad 100 and steps onto the top surface 110 with its entire body. With the cat resting/standing on the pad 100, the device is well anchored so that exercise will not cause the pad to slide around unnecessarily. The cat 195 then extends its front paws 196 and 197 with the digits thereof extending over the rims that have been specifically designed for declawed cats. The top rim is shown in FIG. 1, as the edge that is formed by the junction of the top surface 110 and the side surfaces. As can be seen in FIG. 1, a ledge exists on the left side 140, right side 150 and front side 130 of the exercise pad 100. The lip of the ledge is a second rim, called the ledge rim. After hooking its paws 196 and 197 over the rim(s), the cat 195 then performs the typical and natural action of pulling its digits and front paws toward itself (generally first one paw and then the other) in a stretching and muscle strengthening action. The rims allow the declawed cat 195 to gain sufficient purchase with its front paws such that the paws do not automatically just slide along the top surface 110, which would negate the exercise benefits of the cat's actions.

This action described above releases the cat's special scent from the pads of the front feet and identifies the exercise pad 100 as belonging to the cat 195. The rims of the exercise pad 100 are firm, but also have some “give” and texture so it is satisfying to the declawed cat 195 and replicates many of the natural scratching sensations. The hindquarters of the cat 195 remain secure due to the suitably coarse top surface 110 of the exercise pad 100. The cat 195 may continue this scratching/exercising action for a short time and then sit relaxed on the exercise pad 100, enjoying the feeling of well-being and satisfaction from having been able to scratch as nature intended. It is possible the cat 195 may choose to sleep or simply rest on the exercise pad 100, which further satisfies its sense of security and happiness.

A preferred embodiment of the exercise pad 100 utilizes corrugated cardboard materials to provide the spongy yet relatively strong, lightweight, and inexpensive construction material comprising a portion of the pad 100. FIG. 1 shows a plurality of corrugations 105; instead of illustrating the entire surfaces as being corrugated, the drawings show only partial corrugations so as not to make the drawings overly complicated and busy. However, those skilled in the art will understand that it is preferred that the majority of the surfaces comprise a material that is somewhat spongy and yet relatively strong, lightweight and inexpensive, such as corrugated cardboard or similar materials.

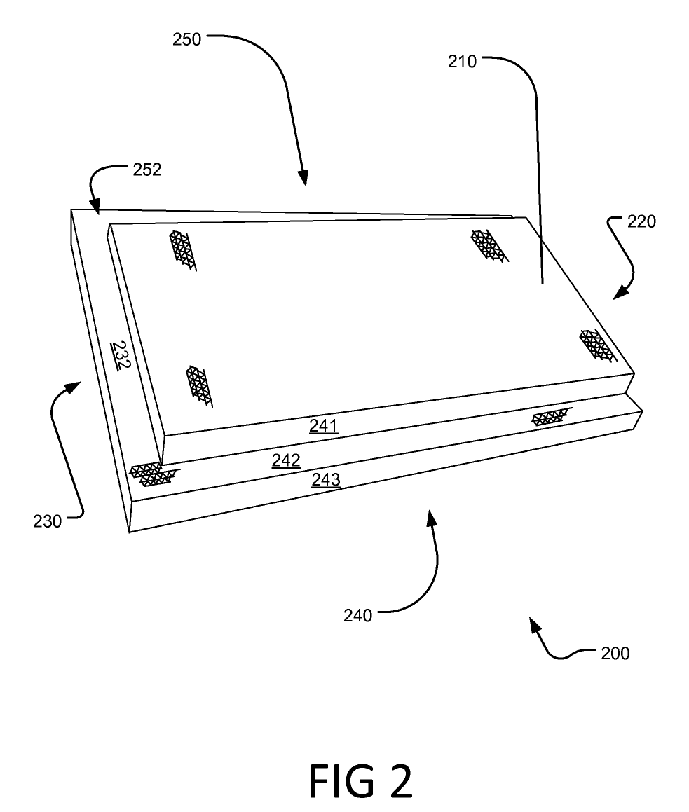

FIG. 2 illustrates a perspective view of an exemplary embodiment of an exercise pad 200 showing a ledge 232, 242 and 252 and a top surface 210. In the embodiment shown in FIG. 2, the ledge 232, 242 and 252 extends along three of the sides of the pad 200: the left side 240, the front side 230 and the right side 250 of the pad 200. In the embodiment illustrated in FIG. 2, the rear side 220 is a continuous vertical surface and does not have a ledge.

The portion of the ledge 242 on the left side 240 of the pad 200 is located between the first generally vertical left side surface 241 and the second generally vertical left side surface 243. Two rims are formed by the junction or abutting of surfaces on the left side 240: the top rim or second left rim that is formed by the junction of the top surface 210 and the second generally vertical left side surface 241, and the ledge rim that is formed by the junction of the ledge 242 surface and the first generally vertical left side surface 243.

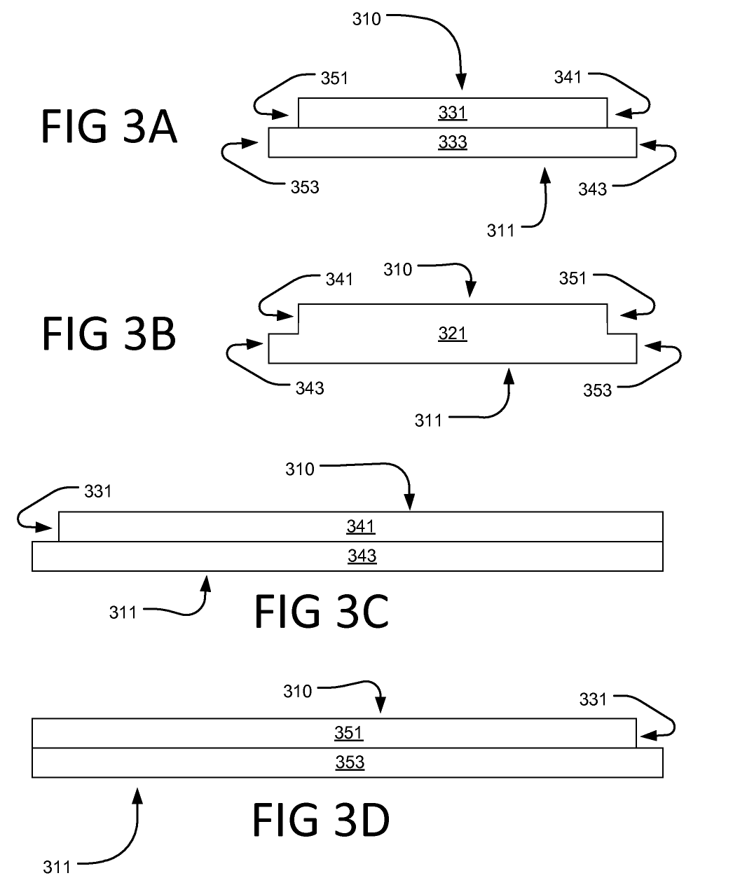

The front portion of the ledge 232 on the front side 230 of the pad 200 is located between the second generally vertical front side surface (not labeled in FIG. 2, see FIG. 3A, item 331) and the first generally vertical front side surface (not labeled in FIG. 2, see FIG. 3A, item 333). Two rims are formed by the junction of surfaces on the front side 230: the top rim or second front rim that is formed by the junction of the top surface 210 and the second generally vertical front side surface (see item 331), and the ledge rim or first front rim that is formed by the junction of the ledge 232 surface and the first generally vertical front side surface (see item 333).

Although not explicitly shown in FIG. 2, the following can be easily deduced from the above descriptions and the FIGURES taken in totality. The portion of the ledge 252 on the right side 250 of the pad 200 is located between the second generally vertical right side surface (see FIG. 3D, item 351) and the first generally vertical right side surface (see FIG. 3D, item 353). Two rims are formed by the junction of surfaces on the right side 250: the top rim or second right rim that is formed by the junction of the top surface 210 and the second generally vertical right side surface (see item 351), and the ledge rim or first right rim that is formed by the junction of the ledge 252 surface and the first generally vertical right side surface (see item 353).

All of these surfaces serve to provide various edges or rims on which a declawed cat can anchor its paws since it can not just sink its claws into the top surface 210 like a non-declawed cat would do. If a cat has been declawed, the need and desire to carry out the instinctive act of scratching remains because this behavior is fundamental to a cat's overall well-being and good health. Consequently, it is important to provide the declawed cat an opportunity to continue the practice of this natural scratching behavior and garner the associated benefits from the behavior.

One benefit that cats enjoy from scratching is the scent-marking of their territories. Cats are compelled to scent mark their territory and such marking is a significant part of any cat's activities, declawed or not. The feline way of life is individualistic with emphasis on owning their territory. Cats have scent glands located in the pads of their front feet and the scratching action of pulling their paws across a suitable surface releases their unique scent that marks the object as their own. Property, ownership and boundaries are a major part of how a cat relates to the world and he has a high need for these to be staked out, respected and defended; thus, marking becomes exceptionally important to a cat's feelings of security, safety, contentment and peace. It is essential to recognize the significance of the activity of “scratching” and the associated benefits for the declawed cat in particular and provide the necessary equipment.

Another more obvious benefit from the action of scratching is that it tones and exercises muscles and stretches limbs. The cat's motion of stretching forward and the resistance created by the pulling and tugging of their paws against a suitable area strengthens the muscles in the front and back legs, chest, shoulders, and spine of the cat. Maintaining good muscle strength in these areas is vital to the cat's overall good health. Scratching using the described exercise pad 200 thus helps declawed cats guard against soft, atrophied muscles and assists in maintaining the suppleness and flexibility so necessary to the cat's natural being.

The action of scratching also provides valuable foot muscle extension and foot exercise, which is especially important to declawed cats to help keep their paws strong and problem free. Furthermore, the scratching movements promote proper body alignment and general exercise, as well as assisting in keeping the declawed cat's body limber and eliminating muscle stiffness. This type of exercise is one of the ingredients to a long and healthy life for a declawed cat.

Scratching activity can also be a powerful stress reducer and a part of the cat's approach to problem-solving and/or relieving frustration. Declawed cats especially need this benefit as problems associated with not having claws can increase their stress and frustration levels. Providing adequate opportunity to carry out this behavior can offer a simple resolution to potential conflicts in a multi-cat household and is an important benefit of scratching behavior.

When the exercise pad 200 is being properly used, it will have bent and tattered edges. Such is a visible territory marker to the cat; and the more visible, the better because it is proof to the cat that the article is its property. Respect of territory and boundaries, which relates to feelings of security, is fundamental and incredibly important to a cat even if the cat is declawed.

The activity of scratching provides mental and physical stimulation for declawed cats, helping keep the cat well, happy and content. Declawed cats scratch because it feels really great to satisfy the built-in urge to do so and because it is an enjoyable activity. It's a source of entertainment and relaxation due, in part, to the rhythmic scratching action and the resistance provided by a suitable scratching surface, such as that shown in FIG. 2 as top surface 210.

FIG. 3A illustrates a side elevational view of the front side of an exemplary embodiment of an exercise pad. The second generally vertical front side surface 331 is shown as is the first generally vertical front side surface 333. Although the other surfaces are not visible from this view, they are pointed out using arrows. They include: the top surface 310, the second generally vertical left side surface 341, the first generally vertical left side surface 343, the second generally vertical right side surface 351, the first generally vertical right side surface 353, and the bottom surface 311. The bottom surface 311 may be quite similar to the top surface 310, except for its modified dimensions.

FIG. 3B illustrates a side elevational view of the rear side 321 of an exemplary embodiment of an exercise pad. The rear side 321 does not include a ledge in this embodiment and so has only a single generally vertical rear surface 321. The ledges on the right and left side surfaces are visible and the following surfaces are indicated: the top surface 310, the second generally vertical left side surface 341, the first generally vertical left side surface 343, the second generally vertical right side surface 351, the first generally vertical right side surface 353, and the bottom surface 311. Where the rear surface 321abuts the top surface 310, the rear rim is formed.

FIG. 3C illustrates a side elevational view of the left side of an exemplary embodiment of an exercise pad. The second generally vertical left side surface 341 is shown as is the first generally vertical left side surface 343. Although the other surfaces are not visible from this view, a number of them are pointed out using arrows. They include: the top surface 310, the second generally vertical front side surface 331, and the bottom surface 311.

FIG. 3D illustrates a side elevational view of the right side of an exemplary embodiment of an exercise pad. The second generally vertical right side surface 351 is shown as is the first generally vertical right side surface 353. Although the other surfaces are not visible from this view, a number of them are pointed out using arrows. They include: the top surface 310, the second generally vertical front side surface 331, and the bottom surface 311.

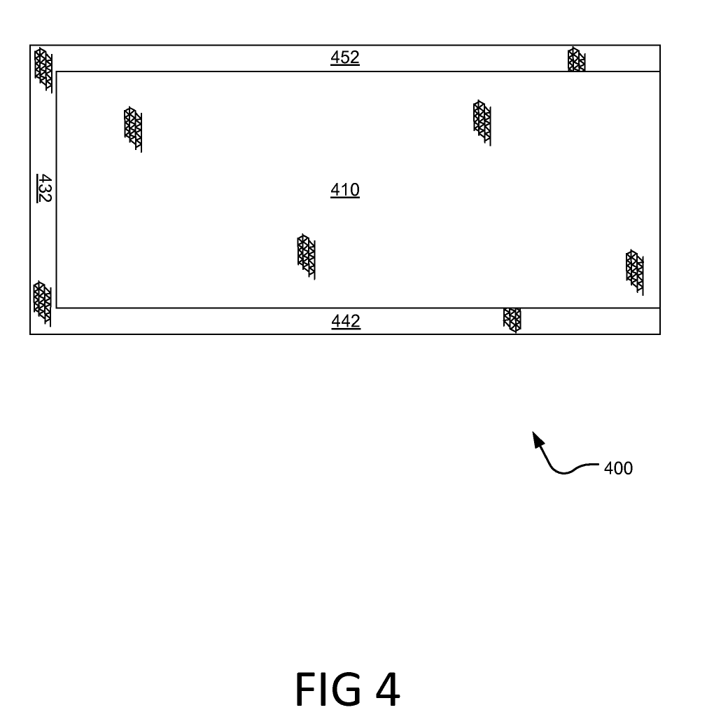

FIG. 4 illustrates a top plan view of an exemplary embodiment of an exercise pad for declawed cats 400. The top surface 410 is clearly shown as are the ledge surfaces 442, 432, and 452 that make up the ledge. The left side of the pad 400 has a left side ledge surface 442. The front side of the pad 400 has a front side ledge surface 432. The right side of the pad 400 has a right side ledge surface 452. As noted above, in other embodiments, the ledge may run along one, two, three, or four sides. Furthermore, if the pad 400 is turned over so that the top surface 410 is facing downwards, the ledge becomes an overhang and it can be easily contemplated that a combination of overhangs and ledges could be used on the same pad. Additionally, the pad need not be four sided, it could have one, two, three, five, six, or more sides and, when viewed from a top plan angle, it could be shaped like a circle or ellipse, a football, a triangle, a quadrilateral, a pentagon, etc. The sides do not necessarily have to be equal to each other and various shapes are therefore contemplated.

The exercise pad for declawed cats can be made more attractive to the cat by the optional use of catnip. Most cats, but not all, greatly enjoy the effect of catnip and have a “catnip response” from inhaling the odors of this herb. An application of a small amount of catnip can be rubbed into the surface or any part of the exercise pad, which will delight and please the cat, as well as encourage the use of the exercise pad.

While particular embodiments of the invention have been described and disclosed in the present application, it should be understood that any number of permutations, modifications, or embodiments may be made without departing from the spirit and scope of this invention. Accordingly, it is not the intention of this application to limit this invention in any way except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise embodiment or form disclosed herein or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

In light of the above “Detailed Description,” the Inventor may make changes to the invention. While the detailed description outlines possible embodiments of the invention and discloses the best mode contemplated, no matter how detailed the above appears in text, the invention may be practiced in a myriad of ways. Thus, implementation details may vary considerably while still being encompassed by the spirit of the invention as disclosed by the inventor. As discussed herein, specific terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

The above specification, examples and data provide a description of the structure and use of exemplary implementations of the described articles of manufacture and methods. It is important to note that many implementations can be made without departing from the spirit and scope of the invention.

What is claimed is:

1. An exercise pad for declawed cats, comprising:
a top surface extending generally horizontally and having a top perimeter and a bottom surface positioned below the top surface, the bottom surface extending generally horizontally and having a bottom perimeter;
the top surface comprising layered corrugated materials having both structure and empty air pockets, the air pockets extending generally vertically and a plurality of layers of corrugation adhered together, wherein the plurality of layers are stacked generally horizontally;
a left side and a right side;
the left side extending generally vertically and extending between a left portion of the top perimeter of the top surface and a left portion of the bottom perimeter of the bottom surface;
the left side having a first generally vertical left surface, a second generally vertical left surface, and a generally horizontal left ledge surface therebetween;
the generally horizontal left ledge surface abutting the first generally vertical left surface forming a first left rim therebetween;
the second generally vertical left surface abutting the left portion of the top perimeter of the top surface and forming a second left rim therebetween;
the right side extending generally vertically and extending between a right portion of the top perimeter of the top surface and a right portion of the bottom perimeter of the bottom surface;
the right side having a first generally vertical right surface, a second generally vertical right surface, and a generally horizontal right ledge surface therebetween;
the generally horizontal right ledge surface abutting the first generally vertical right surface forming a first right rim therebetween;
the second generally vertical right surface abutting the right portion of the top perimeter of the top surface and forming a second right rim therebetween; and
wherein the first left rim, the second left rim, the first right rim, and the second right rim are shaped so as to allow a declawed cat's paws to gain adequate purchase thereon so as to allow the cat to perform a scratching exercise motion.

2. The exercise pad for declawed cats of claim 1 further comprising:
the bottom surface comprising layered corrugated materials having both structure and empty air pockets, the air pockets extending generally vertically and wherein the layered corrugated materials are stacked generally horizontally.

3. The exercise pad for declawed cats of claim 1 further comprising:
a front side;
the front side extending generally vertically and extending between a front portion of the top perimeter of the top surface and a front portion of the bottom perimeter of the bottom surface;
the front side having a first generally vertical front surface, a second generally vertical front surface, and a generally horizontal front ledge surface therebetween;
the generally horizontal front ledge surface abutting the first generally vertical front surface forming a first front rim therebetween;
the second generally vertical front surface abutting the front portion of the top perimeter of the top surface and forming a second front rim therebetween; and
wherein the first front rim and the second front rim are shaped so as to allow a declawed cat's paws to gain adequate purchase thereon so as to allow the cat to perform a scratching exercise motion.

4. The exercise pad for declawed cats of claim 2 further comprising:
a front side;
the front side extending generally vertically and extending between a front portion of the top perimeter of the top surface and a front portion of the bottom perimeter of the bottom surface;
the front side having a first generally vertical front surface, a second generally vertical front surface, and a generally horizontal front ledge surface therebetween;
the generally horizontal front ledge surface abutting the first generally vertical front surface forming a first front rim therebetween;
the second generally vertical front surface abutting the front portion of the top perimeter of the top surface and forming a second front rim therebetween; and
wherein the first front rim and the second front rim are shaped so as to allow a declawed cat's paws to gain adequate purchase thereon so as to allow the cat to perform a scratching exercise motion.

5. The exercise pad for declawed cats of claim 1 further comprising:
a rear side;
the rear side extending generally vertically and extending between a rear portion of the top perimeter of the top surface and a rear portion of the bottom perimeter of the bottom surface;
the rear side having a generally vertical rear surface;
the generally vertical rear surface abutting the rear portion of the top perimeter of the top surface and forming a rear rim therebetween; and
wherein the rear rim is shaped so as to allow a declawed cat's paws to gain adequate purchase thereon so as to allow the cat to perform a scratching exercise motion.

6. The exercise pad for declawed cats of claim 2 further comprising:
a rear side;
the rear side extending generally vertically and extending between a rear portion of the top perimeter of the top surface and a rear portion of the bottom perimeter of the bottom surface;
the rear side having a generally vertical rear surface;
the generally vertical rear surface abutting the rear portion of the top perimeter of the top surface and forming a rear rim therebetween; and
wherein the rear rim is shaped so as to allow a declawed cat's paws to gain adequate purchase thereon so as to allow the cat to perform a scratching exercise motion.

7. The exercise pad for declawed cats of claim 3 further comprising:
a rear side;
the rear side extending generally vertically and extending between a rear portion of the top perimeter of the top surface and a rear portion of the bottom perimeter of the bottom surface;
the rear side having a generally vertical rear surface;
the generally vertical rear surface abutting the rear portion of the top perimeter of the top surface and forming a rear rim therebetween; and
wherein the rear rim is shaped so as to allow a declawed cat's paws to gain adequate purchase thereon so as to allow the cat to perform a scratching exercise motion.

8. The exercise pad for declawed cats of claim 4 further comprising:
a rear side;
the rear side extending generally vertically and extending between a rear portion of the top perimeter of the top surface and a rear portion of the bottom perimeter of the bottom surface;
the rear side having a generally vertical rear surface;
the generally vertical rear surface abutting the rear portion of the top perimeter of the top surface and forming a rear rim therebetween; and
wherein the rear rim is shaped so as to allow a declawed cat's paws to gain adequate purchase thereon so as to allow the cat to perform a scratching exercise motion.
